(19) United States
(12) Patent Application Publication
(10) Pub. No.: US 2014/0116547 A1
(43) Pub. Date: May 1, 2014

(54) FUEL SUPPLY DEVICE

(71) Applicant: ASIAN KOGYO KABUSHIKI KAISHA, Aichi-ken (JP)

(72) Inventor: Yoshihiko Honda, Aichi-ken (JP)

(73) Assignee: ASIAN KOGYO KABUSHIKI KAISHA, Aichi-ken (JP)

(21) Appl. No.: 14/058,791

(22) Filed: Oct. 21, 2013

(30) Foreign Application Priority Data
Nov. 1, 2012 (JP) 2012-241606

(51) Int. Cl. B60K 15/077

(52) U.S. Cl. CPC B60K 15/077
USPC 137/565.37

(57) ABSTRACT

A fuel supply device comprises a fuel tank, a reserve cup, a fuel pump, a jet pump, a fuel supply path, an air introducing path, and a gating mechanism. A fuel pump is disposed inside the reserve cup, and configured to inhale fuel in the reserve cup to exhale a part of the fuel to outside the fuel tank. A fuel supply path connects the fuel pump with the jet pump, and is configured to supply the other part of the fuel exhaled by the fuel pump to the jet pump. An air introducing path is in communication with the fuel supply path, and includes an air hole configured to introduce air from outside the fuel pump. A gating mechanism is configured to close the air hole when the fuel pump is driven, and to open the air hole when the fuel pump stops driving.

### CROSS-REFERENCE TO RELATED APPLICATION(S)

This application claims priority to Japanese Patent Application No. 2012-241606 filed on Nov. 1, 2012, the contents of which are hereby incorporated by reference into the present application.

### TECHNICAL FIELD

The present application relates to a fuel supply device.

### DESCRIPTION OF RELATED ART

In the fuel supply device disclosed in Japanese Patent Application Publication No. 2004-293524, a fuel pump and a jet pump are connected by a path member, and fuel exhaled by the fuel pump is supplied to the jet pump via the path member. An air hole is formed in this path member. The air hole is formed on an inner side of a reserve cup, and fuel that leaks from the air hole is returned to the interior of the reserve cup.

### BRIEF SUMMARY OF INVENTION

In the conventional fuel supply device described above, when the fuel pump stops driving, the path member is kept at atmospheric pressure via the air hole, and the occurrence of a siphoning effect is prevented. Furthermore, in this fuel supply device, the air hole is formed on the inner side of the reserve cup, and therefore fuel leaking out from the air hole while the fuel pump is driven is returned to the reserve cup. Therefore, decrease in the amount of fuel in the reserve cup due to the fuel leaking out from the air hole is prevented. However, if a portion of the fuel supplied from the fuel pump to the jet pump leaks out from the air hole, then the efficiency of the jet pump declines and the amount of fuel taken up by the jet pump decreases. Therefore, a need arises to increase the amount of fuel supplied to the jet pump from the fuel pump and the efficiency of the fuel pump declines accordingly.

Japanese Patent Application Publication No. 2004-293524 focuses on the relationship between the size of the diameter of the air hole and the amount of fuel taken up by the jet pump, and discloses a diameter of the air hole which does not cause great decrease in the amount of fuel taken up by the jet pump. However, as long as an air hole is formed in the fuel supply path, it is not possible to avoid leaking of a portion of the fuel supplied from the fuel pump to the jet pump, via the air hole. Consequently, in a conventional fuel supply device, decline in the efficiency of the fuel pump is inevitable.

The present description presents technology which suppresses decline in the efficiency of a fuel pump, while also suppressing the occurrence of a siphoning effect when the fuel pump stops driving.

A fuel supply device disclosed in the present description comprises a fuel tank, a reserve cup, a fuel pump, a jet pump, a fuel supply path, an air introducing path, and a gating mechanism. A reserve cup is disposed inside the fuel tank. A fuel pump is disposed inside the reserve cup, and configured to inhale fuel in the reserve cup to exhale a part of the fuel to outside the fuel tank. A jet pump is driven by another part of the fuel exhaled by the fuel pump, and configured to inhale fuel in the fuel tank to exhale the fuel to inside the reserve cup. A fuel supply path connects the fuel pump with the jet pump, and is configured to supply the other part of the fuel exhaled by the fuel pump to the jet pump. An air introducing path is in communication with the fuel supply path, and includes an air hole configured to introduce air from outside the fuel pump. A gating mechanism is configured to close the air hole when the fuel pump is driven, and to open the air hole when the fuel pump stops driving.

This fuel supply device is provided with an air introducing path in communication with the fuel supply path, and a gating mechanism configured to open and close the air hole formed in the air introducing path. When the fuel pump is driven, the gating mechanism closes the air hole. On the other hand, when the fuel pump stops driving, the gating mechanism opens the air hole. By adopting this composition, the air hole is closed when the fuel pump is driven, and therefore when fuel is supplied from the fuel pump to the jet pump, it is possible to suppress this fuel leaks out from the air hole. As a result of this, it is possible to suppress decline in the efficiency of the fuel pump. On the other hand, the air hole is opened when the fuel pump stops driving, and therefore air is introduced into the air introducing path from outside the fuel pump. As a result of this, air is also introduced into the fuel supply path which is in communication with the air introducing path, and the air introducing path and the fuel supply path are kept at atmospheric pressure. Consequently, even in a case where the fuel level in the reserve cup is higher than the fuel level in the fuel tank when the fuel pump stops driving, it is possible to suppress the fuel in the reserve cup from flowing into the fuel tank due to a siphoning effect. In other words, by adopting a gating mechanism which closes the air hole when the fuel pump is driven and opens the air hole when the fuel pump stops driving, decline in the efficiency of the fuel pump is suppressed and the occurrence of a siphoning effect when the fuel pump stops driving can also be suppressed.

### BRIEF DESCRIPTION OF DRAWINGS

FIG. 1 shows a cross-sectional diagram of a fuel supply device according to a first embodiment;

FIG. 2 shows a partial enlarged diagram of the vicinity of the upper body of the fuel pump in FIG. 1;

FIG. 3 shows a cross-sectional view along line III-III in FIG. 2;

FIG. 4 shows a cross-sectional diagram of a fuel supply device according to a second embodiment;

FIG. 5 shows a partial enlarged diagram of the vicinity of the upper body of the fuel pump in FIG. 4;

FIG. 6 shows a modification example of a fuel supply device according to the second embodiment;

FIG. 7 shows a cross-sectional diagram of a fuel supply device according to a third embodiment;

FIG. 8 shows a partial enlarged diagram of the fuel supply path in FIG. 7;

FIG. 9 shows one modification example of a fuel supply device according to the third embodiment;

FIG. 10 shows another modification example of a fuel supply device according to the third embodiment;

FIG. 11 shows the other modification example of a fuel supply device according to the third embodiment;

FIG. 12 shows a cross-sectional diagram of a fuel supply device according to the fourth embodiment.

### DETAILED DESCRIPTION OF INVENTION

In one aspect of the present teachings, a portion where the fuel supply path and the air introducing path are communicated with each other may be located at a higher position than a fuel, level in the reserve cup when the reserve cup reserves a necessary amount of fuel to start driving the fuel pump. By adopting this composition, since fuel required to start driving the fuel pump is reserved in the reserve cup, then fuel can be supplied appropriately from the start of driving of the fuel pump.

In another aspect of the present teachings, the gating mechanism may be disposed outside the fuel supply path. By adopting this composition, the flow of fuel inside the fuel supply path is not obstructed by the gating mechanism, and therefore decline in the efficiency of the jet pump can be suppressed.

In another aspect of the present teachings, the air introducing path may be disposed inside the fuel pump, and a portion where the fuel supply path and the air introducing path are communicated with each other is located inside the fuel pump. By adopting this composition, the air introducing path is formed inside the fuel pump, and therefore the fuel supply device can be prevented from becoming large in size.

In another aspect of the present teachings, the fuel, supply path and the air introducing path may be connected with each other, and an extending direction of the fuel supply path intersects with an extending direction of the air introducing path at a portion where the fuel supply path and the air introducing path are connected with each other. By adopting this composition, the gating mechanism can reliably close the air hole when the fuel pump is driving, and can reliably open the air hole when the fuel pump stops driving.

In another aspect of the present teachings, the fuel supply path may comprise a first fuel supply path, and a second fuel supply path that is branched from the first fuel supply path and is parallel with the first fuel supply path. The air introducing path may be connected with either the first fuel supply path or the second fuel supply path. In this fuel supply device, the air introducing path is connected to one of the two fuel supply paths. When the fuel pump is driven, even it for instance, the gating mechanism closes off a portion of the one fuel supply path, thereby decreasing the amount of fuel flowing in the fuel supply path, the fuel exhaled from the fuel pump is supplied to the jet pump via the other fuel supply path (in other words, via the path to which the air introducing path is not connected). By adopting this composition, increase in the flow path resistance of the fuel supply path due to the gating mechanism is suppressed, and decline in the efficiency of the jet pump can be suppressed.

In another aspect of the present teachings, the gating mechanism may be disposed inside the fuel supply path in a case where the gating mechanism opens the air hole, and at least a part of the gating mechanism may retract from the fuel supply path in a case where the gating mechanism closes the air hole. In this fuel supply device, the gating mechanism is disposed inside the fuel supply path when the fuel pump stops driving. In other words, the gating mechanism is disposed so as to close off at least a portion of the fuel supply path. However, when the fuel pump is driven, at least a portion of the gating mechanism moves, thereby ensuring a space for fuel to flow along the fuel supply path. By adopting this composition, even if the gating mechanism is disposed inside the fuel supply path when the fuel pump stops driving, it is possible to suppress decrease in the amount of fuel supplied to the jet pump when the fuel pump is driven, and decline in the efficiency of the jet pump can be suppressed.

In the other aspect of the present teachings, the gating mechanism may comprise a valve element and a valve seat, and the valve element may make tight contact with the valve seat to close the air hole by a fluid force of the fuel when the fuel pump is driven. By adopting this composition, the air hole can be opened or closed reliably, by the valve element and the valve seat. Furthermore, there is no need to provide a new control device for operating the gating mechanism, and therefore the gating mechanism can be manufactured easily.

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved fuel supply pump, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### EMBODIMENTS

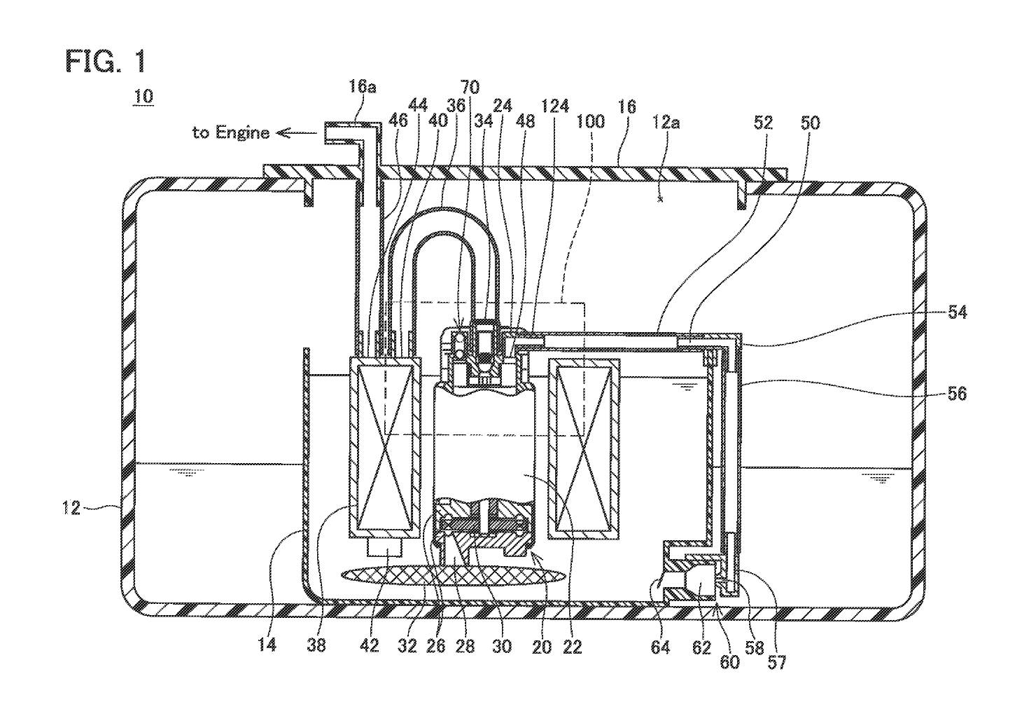

A fuel supply device 10 according to a first embodiment of the invention will now be described with reference to the drawings. As shown in FIG. 1, the fuel tank 12 has an opening 12a on an upper wall thereof. A flange 16 is a plate made of resin, which is fitted into the opening 12a of the fuel tank 12 so as to cover the opening 12a. A connecting pipe 16a is formed in the flange 16. One end of the connecting pipe 16a is connected to a fuel supply pipe 46, which is described hereinafter. A reserve cup 14 is disposed inside the fuel tank 12. The reserve cup 14 is a lidless container having a bottom, inside which a fuel pump 20, a suction filter 32, a filter 38 and a jet pump 60 are accommodated. Fuel is reserved respectively in the fuel tank 12 and the reserve cup 14.

An outer wall of the fuel pump 20 is constituted by a round cylindrical housing 22, an upper body 24 which closes off an opening at an upper end of the housing 22, and a casing 26 which closes off an opening at a lower end of the housing 22. An exhalation port 34, a jet pump exhalation port 48 and an air hole sealing valve 70 are provided in the upper body 24. One end of the fuel supply pipe 36 is connected to the exhalation port 34. The jet pump exhalation port 48 is in communication with a guide pipe 124 which is formed on the upper body 24. The guide pipe 124 is connected to the jet pump 60 via a first connecting pipe 52, a second connecting pipe 54, a third connecting pipe 56 and a fourth connecting pipe 57. The first connecting pipe 52, the second connecting pipe 54, the third connecting pipe 56 and the fourth connecting pipe 57 according to the present embodiment are each made of resin. A fuel supply path 50 is formed by the guide pipe 124, the first connecting pipe 52, the second connecting pipe 54, the third connecting pipe 56 and the fourth connecting pipe 57. In other words, the fuel pump 20 and the jet pump 60 are connected via the fuel supply path 50. As shown in FIG. 1, the air hole sealing valve 70 is disposed outside the fuel supply path 50. The air hole sealing valve 70 is described in detail below. An inhalation port 28 for inhaling fuel in the reserve cup 14 is provided in the casing 26. A suction filter 32 is attached to the inhalation port 28. The suction filter 32 removes foreign matter from the fuel inhaled into the fuel pump 20. An impeller 30 is accommodated in the casing 26. The impeller 30 is driven to rotate by a motor disposed inside the fuel pump 20, and inhales fuel in the reserve cup 14 via the inhalation port 28.

The filter 38 is disposed so as to cover the outer circumference of the fuel pump 20, and a filter inhalation port 40 and a filter exhalation port 44 are provided in an upper portion of the filter 38, while a pressure adjusting valve 42 is provided in a lower portion thereof. The other end of the fuel supply pipe 36 is connected to the filter inhalation port 40. One end of the fuel supply pipe 46 is connected to the filter exhalation port 44, and the other end of the fuel supply pipe 46 is connected to one end of the connecting pipe 16a. The pressure adjusting valve 42 adjusts a pressure of the fuel inside the filter 38. That is, the pressure adjusting valve 42 adjusts the pressure of the fuel in the filter 38, by opening so as to lower the pressure in a case where the pressure of the fuel in the filter 38 is equal to or greater than a predetermined pressure. Consequently, the pressure of the fuel exhaled from the filter 38 to the fuel supply pipe 46 is adjusted to a desired pressure. The fuel exhaled from the pressure adjusting valve 42 is returned to the reserve cup 14.

The jet pump 60 is disposed on the outer wall of the reserve cup 14. The jet pump 60 is provided with an inhalation port 62 and a non-reversing valve 64. The inhalation port 62 is disposed so as to oppose a spray port 58 which is formed in the fourth connecting pipe 57. The non-reversing valve 64 prevents reverse flow of the fuel inhaled into the reserve cup 14 from the fuel tank 12.

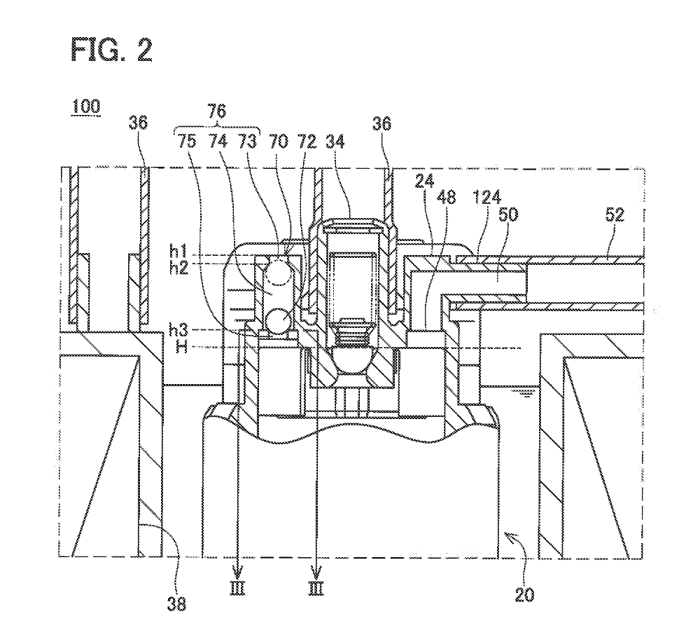

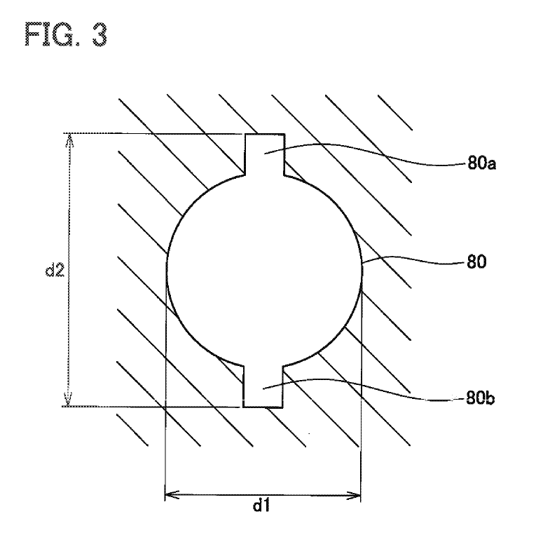

Next, the air hole sealing valve 70 will be described with reference to FIG. 2. FIG. 2 shows an enlarged diagram of a portion 100 of the fuel supply device 10 in FIG. 1, which is surrounded by the dotted lines. An air introducing path 76 is formed in the upper body 24. The air introducing path 76 is composed by a first path 73, a second path 74 and a third path 75. The first path 73 indicates a path from a height h1 to a height h2, the second path 74 indicates a path from the height h2 to a height h3, and the third path 75 indicates a path from the height h3 to a height H. The paths 73, 74, 75 are communicated with each other. The first path 73 is formed in a round cylindrical shape. The upper portion of the second path 74 narrows to a mortar shape towards the upper side (the upward direction in the drawing), and the diameter of the front end thereof is equal to the diameter of the first path 73. Below, for the purposes of the description, the portion where the path narrows to a mortar shape as described above is called a “taper section”. The path of the second path 74 excluding the taper section is formed in a round cylindrical shape. Here, the third path 75 will be described with reference to FIG. 3. FIG. 3 shows a cross-sectional view along line III-III in FIG. 2. The cross-section 80 has projecting sections 80a, 80b respectively located in the far direction and the near direction of the plane of the drawing in FIG. 2. The third path 75 is a bar-shaped path of which the cross-section in the axial direction has the shape of the cross-section 80. Below, the diameter of the cross-section 80, not including the projecting sections 80a, 80b, is called d1, and the diameter of the cross-section 80 including the projecting sections 80a, 80b, is called d2.

The description is now continued by returning to FIG. 2. The diameter of the path excluding the taper section of the second path 74 is greater than the diameter of the first path 73 and the diameter d1 of the third path 75, and is equal to or greater than the diameter d2 of the third path 75. A ball 72 is accommodated in the internal space of the second path 74. The diameter of the ball 72 is slightly smaller than the diameter of the path excluding the taper section of the second path 74, and is greater than the diameter d1 of the first path 73 and the diameter d1 of the third path 75. Consequently, the ball 72 is only able to move in the internal space of the second path 74. More specifically, if the hall 72 moves upwards due to the fuel pressure, then the ball 72 abuts against the first path 73 and the taper section of the second path 74 (that is, the position indicated by height h2) and cannot move further upwards (below, this position is also called “the uppermost portion of the second path 74”). Similarly, if the ball 72 moves downwards, then the ball 72 abuts against an upper end surface of the third path 75 (that is, the position indicated by height h3) and cannot move further downwards (below, this position is also called “the lowermost portion of the second path 74”). As the foregoing reveals, if the ball 72 is positioned in the uppermost portion or the lowermost portion of the second path 74, then strictly speaking, a portion of the ball 72 is positioned inside the first path 73 or the third path 75, but it should be noted that in the present embodiment, the space where the center of the ball 72 is positioned is referred to as the space where the ball 72 moves. An air hole sealing valve 70 is constituted by the air introducing path 76 and the ball 72.

The first path 73 opens in an upper wall of the upper body 24. Due to this opening, the first path 73 is in communication with the outside of the fuel pump 20. Therefore, this opening is called an “air hole” below. The air hole takes in air from outside the fuel pump 20. If the ball 72 is positioned in the uppermost portion of the second path 74, the ball 72 abuts against the taper section of the second path 74 and seals off the lower end section of the first path 73. Therefore, the ball 72 shuts off communication between the first path 73 and the second path 74. That is, the air hole is closed by the ball 72. Below, this is also referred to as “the air hole sealing valve 70 closes”. On the other hand, when the ball 72 is situated at a position other than the uppermost portion of the second path 74, then the first path 73 and the second path 74 are in communication with each other and the air hole is open. Below, this is also referred to as “the air hole sealing valve 70 opens”. If the ball 72 is positioned in the lowermost portion of the second path 74, then due to the presence of the projecting sections 80a, 80b, the upper end portion of the second path 75 is not sealed by the ball 72. That is, the second path 74 and the third path 75 are always communicated with each other by the projecting sections 80a, 80b, regardless of the position of the ball 72. Therefore, if the air hole sealing valve 70 opens, air introduced from the air hole passes from the first path 73, along the second path 74 and flows into the third path 75. That is, air is introduced into the air introducing path 76. In the present embodiment, projecting sections are provided at two positions in the circumferential direction, but the number of projecting sections is not limited to this. Furthermore, the projecting sections may be of any shape, provided that the shape enables the second path 74 and the third path 75 to be kept in a state of communication. Moreover, provided that the ball 72 moves only in the internal space of the second path 74, the shape of the cross-section 80 is not limited to this and may be, for example, a square shape, or a polygonal shape. In this ease, even if the ball 72 is positioned in the lowermost portion of the second path 74, since the second path 74 and the third path 75 are communicated with each other via the corner portions of the cross-sectional shape, then it is not necessary to provide projecting sections 80a, 80b as in the present embodiment. Furthermore, in relation with this, each of the paths in the present embodiment (excluding the taper section of the second path 74 and the projecting sections 80a, 80b of the third path 75) has a round cylindrical shape, but the shape of the second path 74 apart from the taper section thereof, and the shape of the third path 75, are not limited to this and may be a square cylindrical shape, for example. The air hole sealing valve 70 corresponds to one example of a “gating mechanism” and the ball 72 corresponds to one example of a “valve element”. Furthermore, the taper section of the second path 74 which is contacted by the ball 72 corresponds to one example of a “valve seat”.

Moreover, the third path 75 and the fuel supply path 50 are communicated with each other at the height indicated by the dotted line H, inside the fuel pump 20. Consequently, in a case where the ball 72 is situated at a position other than the uppermost portion of the second path 74, the air hole sealing valve 70 opens and air is also introduced into the fuel supply path 50 which is in communication with the air introducing path 76. As shown in FIG. 2, the height H at which the air introducing path 76 and the fuel supply path 50 are communicated with each other is located at a higher position than a fuel level in the reserve cup 14 when an amount of fuel necessary to start driving of the fuel pump 20 is reserved in the reserve cup 14.

Next, the operation of the fuel supply device 10 will be described. When current is supplied to the fuel pump 20 from a battery (not illustrated), the fuel pump 20 starts driving. More specifically, the motor turns and in accordance with this, the impeller 30 rotates. When the impeller 30 rotates, the fuel pump 20 inhales fuel in the reserve cup 14 from the inhalation port 28 via the suction filter 32. The inhaled fuel is pressurized by the rotation of the impeller 30, and passes inside the fuel pump 20. Then, a portion of the inhaled fuel is exhaled from the jet pump exhalation port 48, while the remainder of the inhaled fuel is exhaled from the exhalation port 34. Furthermore, the pressurized fuel is also supplied to the third path 75 of the air introducing path 76. The pressurized fuel supplied to the third path 75 pushes the ball 72 up to the uppermost portion of the second path 74, by a fluid force thereof. While the fuel pump 20 is being driven, the space below the hall 72 in the air introducing path 76 is always filled with pressurized fuel. Therefore, while the fuel pump 20 is being driven, the ball 72 continues to be situated in the uppermost portion of the second path 74. Consequently, the air hole sealing valve 70 closes and the communication between the fuel pump 20 and the outside is shut off.

The fuel exhaled from the exhalation port 34 is inhaled into the filter 38 from the filter inhalation port 40, via the fuel supply pipe 36. The fuel is filtered by the filter 38 to remove foreign matter, and is then exhaled from the filter exhalation port 44. In this case, the pressure of the fuel inside the filter 38 is controlled by the pressure adjusting valve 42. That is, in a case where the pressure of the fuel in the filter 38 is higher than a predetermined pressure, the pressure adjusting valve 42 opens and a portion of the fuel is returned to the reserve cup 14, thereby keeping the pressure of the fuel in the filter 38 within a predetermined pressure range. The exhaled fuel is supplied via the fuel supply pipe 46 to the engine, from the connecting pipe 16a.

On the other hand, the fuel exhaled from the jet pump exhalation port 48 passes along the fuel supply path 50 and is supplied to the jet pump 60 from the spray port 58. If fuel is sprayed from the spray port 58, then the periphery of the spray port 58 becomes a negative pressure, and the jet pump 60 sucks the fuel in the periphery of the spray port 58 (that is, the fuel in the fuel tank 12), via the inhalation port, and this fuel flows into the reserve cup 14. That is, due to the fuel pump 20 passing fuel via the fuel supply path 50 and spraying fuel from the spray port 58, the jet pump 60 is driven and the fuel in the fuel tank 12 is inhaled into the reserve cup 14. The jet pump 60 is provided with a non-reversing valve 64 and the fuel which has been inhaled via the inhalation port 62 is prevented from flowing back from the reserve cup 14 to the fuel tank 12.

When supply of current from the battery to the fuel pump 20 is halted, the fuel pump 20 stops inhalation of fuel. In so doing, the ball 72 in the second path 74 of the air introducing path 76 moves to the lowermost portion of the second path 74, due to gravitational force, and the air hole sealing valve 70 opens. When the air hole sealing valve 70 opens, air outside the fuel pump 20 is taken in via the air hole, and the third path 75 becomes atmospheric pressure via the first path 73 and the second path 74. That is, the interior of the air introducing path 76 becomes atmospheric pressure. Therefore, the interior of the fuel supply path 50 which is in communication with the air introducing path 76 also becomes atmospheric pressure.

The advantages of the fuel supply device 10 according to the present embodiment will now be described. When the fuel pump 20 is driven, the air hole sealing valve 70 closes, and therefore fuel inhaled by the fuel pump 20 does not leak out via the air hole. All of the inhaled fuel is supplied to the engine and the jet pump 60. Consequently, there is no requirement to increase the amount of fuel supplied to the jet pump by the fuel pump in order to compensate for the amount of fuel leaking out from the air hole, as in a conventional fuel supply device. As a result of this, it is possible to suppress decline in the efficiency of the fuel pump 20. Furthermore, when the fuel pump 20 stops driving, the air hole sealing valve 70 opens and the fuel supply path 50 which is in communication with the air introducing path 76 becomes atmospheric pressure. Consequently, even in a case where the fuel level in the reserve cup 14 when the fuel pump stops driving is higher than the fuel level in the fuel tank 12., it is possible to prevent the fuel in the reserve cup 14 from flowing out into the fuel tank 12 due to a siphoning effect. That is, when the fuel pump 20 has stopped driving, the fuel in the reserve cup 14 is prevented from flowing back into the fuel tank 12 and the height of the fuel level in the reserve cup 14 can be kept constant.

Furthermore, the height H at which the air introducing path 76 and the fuel supply path 50 are communicated with each other is higher than the fuel level in the reserve cup 14 when an amount of fuel necessary to start driving of the fuel pump 20 is reserved in the reserve cup 14. Therefore, if the fuel pump 20 stops driving and the air hole sealing valve 70 opens, then the interior of the fuel supply path 50 rapidly becomes atmospheric pressure, and the fuel is rapidly prevented from flowing out to the fuel tank 12. Therefore, it is possible to ensure a sufficient amount of fuel in the reserve cup 14.

Furthermore, the air hole sealing valve 70 of the fuel supply device 10 according to the present embodiment is disposed outside the fuel supply path 50. Therefore, it is possible to prevent decrease in the amount of fuel flowing in the fuel supply path 50, by closing off a portion of the fuel supply path 50 by the air hole sealing valve 70, for instance. That is, decrease in the amount of fuel supplied to the jet pump 60 can be prevented. Consequently, decline in the efficiency of the jet pump 60 can be suppressed. Furthermore, the air introducing path 76 is formed inside the fuel pump 20 and the fuel supply path 50 is in communication with the air introducing path 76 inside the fuel pump 20. In recent years, as automobiles have become more compact in size, there has been an increasing need to reduce the size of the fuel supply device 10. Consequently, by adopting a composition of this kind, it is possible to suppress increase in the size of the fuel supply device 10 due to the provision of the air introducing path 76. Furthermore, by disposing the air hole sealing valve 70 outside the fuel supply path 50, it becomes possible to manufacture the air hole sealing valve 70 easily.

Moreover, in the air hole sealing valve 70 according to the present embodiment, a valve element and a valve seat are composed by the ball 72 and the taper section of the second path 74 of the air introducing path 76. When the fuel pump 20 is driven, the ball 72 is pushed up by the fluid force of the pressurized fuel and makes tight contact with the taper section of the second path 74, thereby closing the air hole sealing valve 70. On the other hand, when the fuel pump 20 stops driving, the ball 72 drops due to gravitational force, thereby opening the air hole sealing valve 70. That is, the air hole sealing valve 70 has a simple structure which utilizes the fluid force of the fuel and gravitational force. Therefore, it is not necessary to provide a new controller or actuator for operating the air hole sealing valve 70. For this reason, increase in the size of the fuel supply device 10 can be suppressed. Moreover, since a taper section is formed in the upper portion of the second path 74, the taper section serves to guide the ball 72 towards the uppermost portion of the second path 74. Consequently; when the fuel pump 20 is driven to admit fuel into the air introducing path 76 and the ball 72 is pushed upwards, the ball 72 does not stick, for instance, by catching midway along the path, and can be positioned rapidly at the uppermost portion of the second path 74.

### Second Embodiment

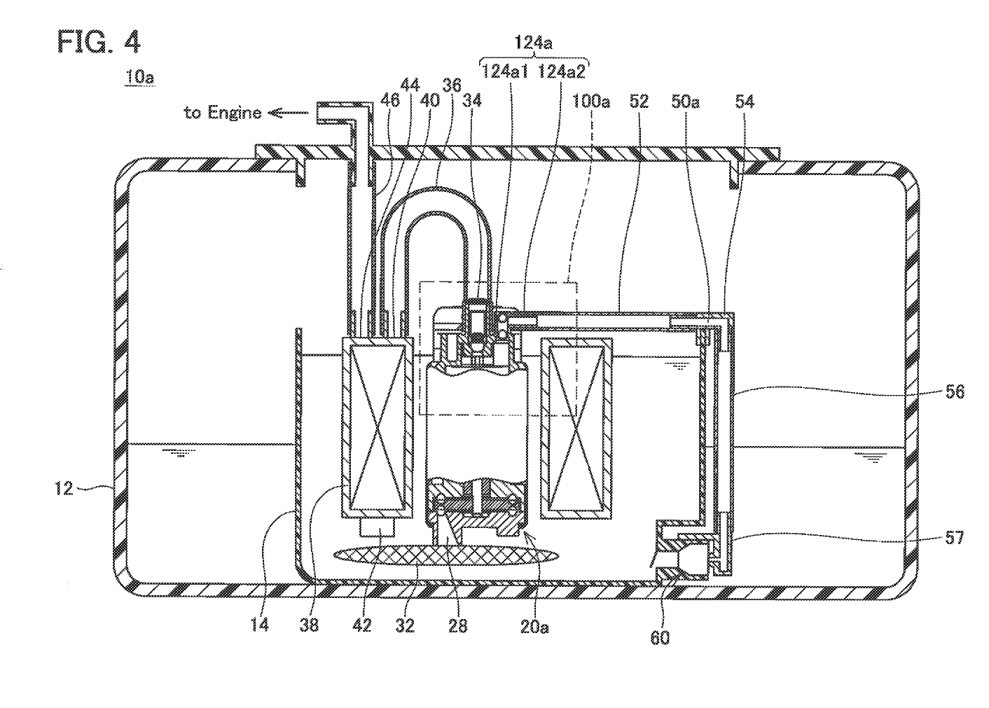

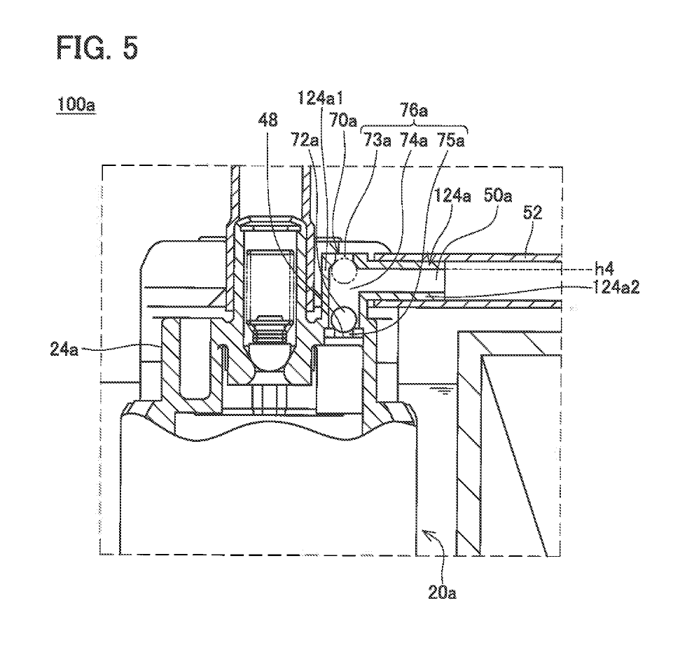

A fuel supply device 10a according to a second embodiment of the invention will now be described with reference to FIG. 4 and FIG. 5. In the fuel supply device 10a according to the second embodiment, a portion of the fuel supply device 10 according to the first embodiment is modified. Therefore, here, the points of difference with respect to the fuel supply device 10 according to the first embodiment will be described. Members which are the same as the fuel supply device according to the first embodiment are labeled with the same reference numerals, and detailed description thereof is omitted here.

FIG. 4 shows the fuel supply device 10a according to the second embodiment, and FIG. 5 shows an enlarged diagram of the portion 100a which is surrounded by the dotted lines in the fuel supply device 10a in FIG. 4. As shown in FIG. 5, a guide pipe 124a is formed in the upper body 24a. The guide pipe 124a is bent at a substantially perpendicular angle so as to have a substantially L-shaped form. One end of the guide pipe 124a is in communication with the jet pump exhalation port 48, and the other end thereof is connected to the first connecting pipe 52. Below, in the guide pipe 124a, a pipe which extends in the vertical direction (the up/down direction in the drawings) is termed a first guide pipe 124a1, and a pipe which is coupled in substantially perpendicular fashion to the first guide pipe 124a1 is termed a second guide pipe 124a2 (below, the portion where the path in the first guide pipe 124a1 and the path in the second guide pipe 124a2 are communicated with each other may simply be called a “communicating section”). The broken line h4 indicates the height of the uppermost portion of the communicating section. As shown in FIG. 4, the second guide pipe 124a2 is connected to the jet pump 60 via the connecting pipes 52, 54, 56, 57. In the present embodiment, a fuel supply path 50a is formed by the guide pipe 124a and the connecting pipes 52, 54, 56, 57. In the first guide pipe 124a1, the path above the height h4 does not function as a path along which the fuel supplied to the jet pump 60 flows.

In the present embodiment, an air introducing path 76a is formed inside the first guide pipe 124a1. More specifically, the air introducing path 76a is composed by a first path 73a, a second path 74a and a third path 75a. The shapes of the paths are the same as in the first embodiment. The first path 73a opens in the upper portion of the first guide pipe 124a1 (that is, an air hole is formed). The third path 75a indicates the path up to the jet pump exhalation port 48, which is in communication with the jet pump exhalation port 48. The second path 74a is in communication with the second guide pipe 124a2 on the outer circumferential surface thereof. A ball 72a is accommodated in the second path 74a. That is, an air hole sealing valve 70a is disposed inside the first guide pipe 124a1. The guide pipe 124a is formed in such a manner that the ball 72a does not close off the communicating section in a case where the ball 72a is positioned in the uppermost portion of the second path 74a. When the fuel pump 20a has stopped driving, the hall 72a is positioned in the lowermost portion of the second path 74a. Furthermore, as shown in FIG. 5, the height at which the fuel supply path 50a and the air introducing path 76a are communicated with each other (that is, the communicating section) is higher than a fuel level in the reserve cup 14 when an amount of fuel necessary to start driving of the fuel pump 20 is reserved in the reserve cup 14, similarly to the first embodiment.

When the fuel pump 20a is driven, the fuel pump 20a inhales fuel from the inhalation port 28 and pressurizes the fuel. A portion of the pressurized fuel is exhaled from the jet pump exhalation port 48 and the remainder of the fuel is exhaled from the exhalation port 34. When fuel is exhaled from the jet pump exhalation port 48, due to the fluid force of the fuel, the ball 72a is pushed up from the lowermost portion of the second path 74a to the uppermost portion of the second path 74a, thereby closing the air hole sealing valve 70a. In this case, a portion of the ball 72a is positioned in a space above the height h4. In other words, a portion of the ball 72a is positioned outside the fuel supply path 50a. Consequently, it can be said that when the air hole sealing valve 70a is closed, a portion of the ball 72a retracts from the fuel supply path 50a. Since a portion of the ball 72a retracts from the fuel supply path 50a, a sufficient flow path is ensured in the fuel supply path 50a. As a result of this, the fuel that has been exhaled from the jet pump exhalation port 48 flows smoothly from the first guide pipe 124a1 to the second guide pipe 124a2 and is supplied to the jet pump 60 via the fuel supply path 50a. When the fuel pump 20a stops driving, the exhalation of fuel from the jet pump exhalation port 48 stops, and the ball 72a drops due to gravitational force and moves to the lowermost portion of the second path 74a. Consequently, the air hole sealing valve 70a opens, air is introduced from the air hole, and the fuel supply path 50a is kept at atmospheric pressure.

In the fuel supply device 10 according to the second embodiment, the air hole sealing valve 70a closes when the fuel pump 20a is driven, and therefore all of the fuel exhaled from the jet pump exhalation port 48 is supplied to the jet pump 60 without leaking midway. Therefore, it is possible to suppress decline in the efficiency of the fuel pump 20a and the jet pump 60. Furthermore, when the fuel pump 20a stops driving, the air hole sealing valve 70a opens and the fuel supply path 50a becomes atmospheric pressure. Therefore, the fuel can be prevented from flowing out into the fuel tank 12 from the reserve cup 14. In the present embodiment, the shape of the cross-section at the boundary between the second path 74a and the third path 75a is the same as in the first embodiment, but the shape of the cross-section may be a round shape which does not have any projecting sections. In this case, the communication between the second path 74a and the third path 75a is shut off by the ball 72a when the fuel pump 20a stops driving, and therefore air is not introduced into the third path 75a. However, in order to suppress the occurrence of a siphoning effect, it is sufficient if air is introduced into the fuel supply path up to the jet pump 60, and hence it should be noted that there is no need for the air to be introduced into the whole of the fuel supply path.

### First Modification Example

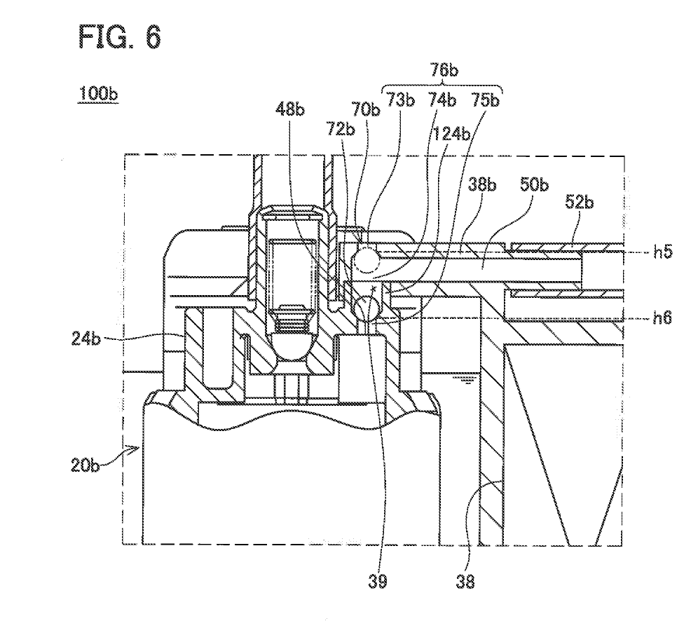

Next, a first modification example of the second embodiment will be described with reference to FIG. 6. Below, only the points which differ from the second embodiment are described, and detailed description of the structure and operation which are the same as the second embodiment is omitted here.

In the fuel supply device according to the first modification example, a projecting pipe 38b is provided in the case which accommodates the filter 38. The projecting pipe 38b is a pipe that extends in the lea/right direction (that is, the left/right direction of the plane of the drawings) and one end of the projecting pipe 38b has openings respectively in the upper portion and the lower portion thereof. Below, the opening formed in the lower portion of the projecting pipe 38b is called “opening 39”. The other end of the projecting pipe 38b is connected to a first connecting pipe 52b. On the other hand, a guide pipe 124b is formed on the upper body 24b. By pressure fitting the guide pipe 124b into the opening 39 of the projecting pipe 38b, the guide pipe 124b and the projecting pipe 38b are communicated with each other. Thereby; an air introducing path 76b is formed. The air introducing path 76b is composed by a first path 73b, a second path 74b and a third path 75b. More specifically, the first path 73b indicates a path from the opening of the projecting pipe 38b (that is, the air hole) to the height h5, the second path 74b indicates a path from the height h5 to the height h6, and the third path 75b indicates a path from the height h6 to the jet pump exhalation port 48b. The lower portion of the second path 74b narrows to a mortar shape towards the lower side (the downward direction in the plane of the drawings), and the diameter of the front end thereof is equal to the diameter of the third path 75 (below; this portion is called a “taper section”). A ball 72b is accommodated in the second path 74b. An air hole sealing valve 70b is constituted by the air introducing path 76b and the ball 72b. The operation of the fuel pump 20b is the same as the operation in the second embodiment and therefore description thereof is omitted here.

In the fuel pump 20h according to the first modification example, a fuel supply path 50b is formed by forming a projecting pipe 38b on the case of the filter 38, rather than by forming a substantially L-shaped guide pipe in the upper body. By adopting a composition of this kind, it is possible to form a fuel supply path 50b relatively easily. In the first modification example, the projecting pipe 38b is assembled on the guide pipe 124b by pressure fitting, but the assembly method is not limited to this. Furthermore, by forming a taper section in the lower portion of the second path 74b, when the ball 72b drops due to gravitational force, the taper section serves to guide the ball 72b towards the lowermost portion of the second path 74b. Consequently, the ball 72b never gets stuck in a corner portion of the second path 74b, or the like, and when the fuel pump 20b is driven, the fuel makes sufficient contact with the ball 72b and the ball 72b can be pushed up appropriately. In the modification example described above, a projecting pipe 38b is formed in the case of the filter 38, but if the fuel supply device is provided with a pump case for accommodating the fuel pump, then a pipe may be formed on the pump case, and the jet pump exhalation port may be connected to this pipe.

### Third Embodiment

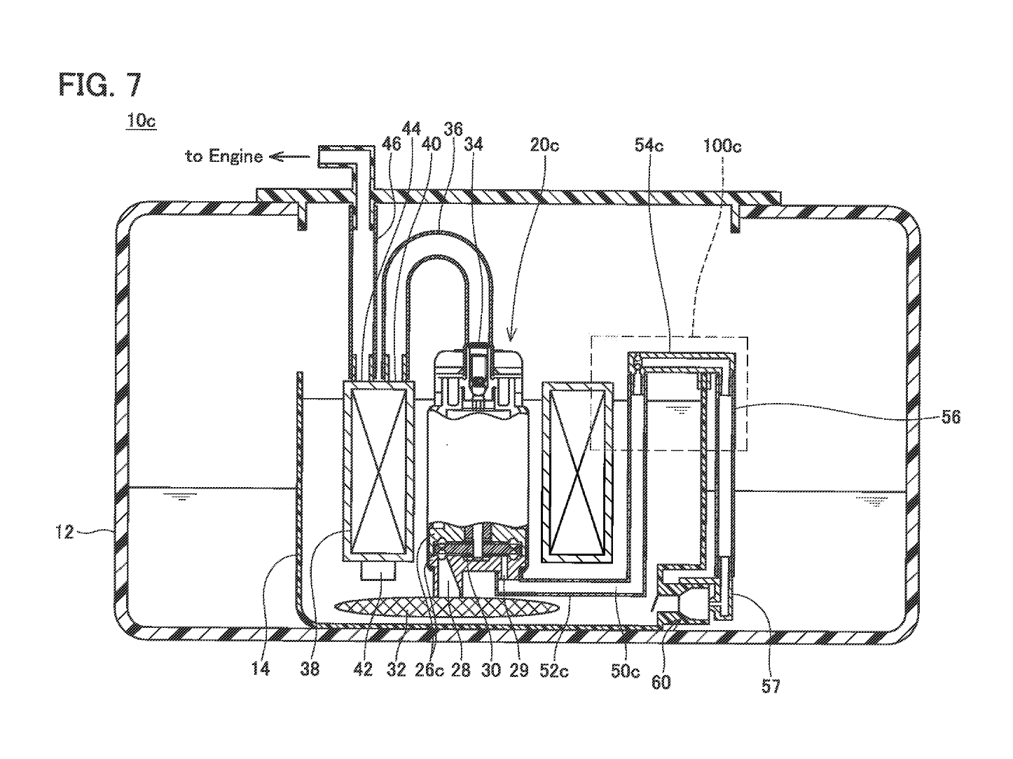

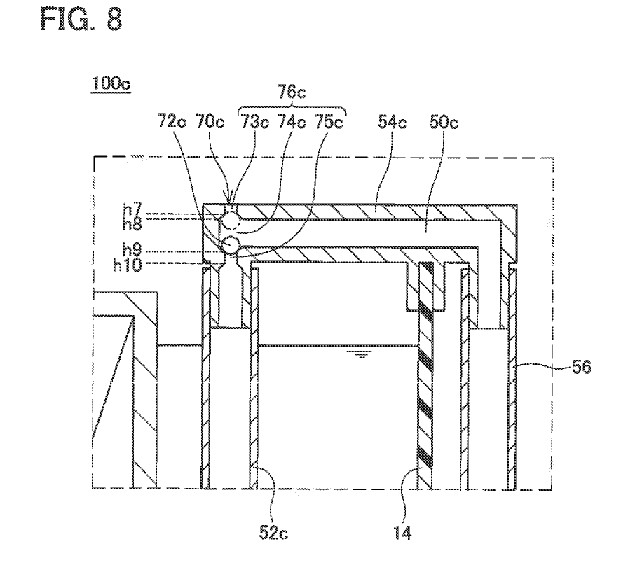

A fuel supply device 10c according to a third embodiment of the invention will now be described with reference to FIG. 7 and FIG. 8. In the fuel supply device 10c according to the third embodiment, a portion of the fuel supply device 10a according to the second embodiment is modified. Therefore, here, the points of difference with respect to the fuel supply device 10a according to the second embodiment will be described. Members which are the same as the fuel supply device 10a according to the second embodiment are labeled with the same reference numerals, and detailed description thereof is omitted here.

FIG. 7 shows the fuel supply device 10e according to the third embodiment, and FIG. 8 shows an enlarged diagram of the portion 100c which is surrounded by the dotted lines in the fuel supply device 10c in FIG. 7. As shown in FIG. 7, a through hole 29 is formed in a casing 26c. The through hole 29 is in communication with an internal space of the casing 26c (that is, the space which accommodates an impeller 30). A first connecting pipe 52c is attached to the lower portion of the fuel pump 20c, so as to be in communication with the through hole 29. The first connecting pipe 52c is connected to a jet pump 60 via a second connecting pipe 54c, a third connecting pipe 56 and a fourth connecting pipe 57. A fuel supply path 50c is formed by the connecting pipes 52c, 54c, 56, 57. That is, in the present embodiment, the fuel supply path 50c extends upwards from the lower portion of the fuel pump 20c and straddles the reserve cup 14, before arriving at the jet pump 60.

Next, an air hole sealing valve 70c according to the present embodiment will be described with reference to FIG. 8. An air introducing path 76c is formed in a corner portion where the second connecting pipe 54c is connected with the first connecting pipe 52c. More specifically, the air introducing path 76c is composed by a first path 73c, a second path 74c and a third path 75c. An opening (that is, an air hole) is formed in an upper portion of the second connecting pipe 54c. The first path 73c indicates a path from the opening to height h7, the second path 74c indicates a path from a height h7 to a height h9, and the third path 75e indicates a path from a height h9 to a height h10. As FIG. 8 reveals, the path above the height h8 does not function as a fuel supply path for supplying fuel to the jet pump 60. The second path 74c is in communication, on the outer circumferential surface thereof, with a path extending in the left/right direction inside the second connecting pipe 54c (this portion may be called “communicating section” below). A ball 72c is accommodated in the second path 74c. The second connecting pipe 54c is formed in such a manner that the ball 72c does not close off the communicating section in a case where the ball 72c is positioned in the uppermost portion of the second path 74c. When the fuel pump 20c has stopped driving, the ball 72c is positioned in the lowermost portion of the second path 74c. Furthermore, as shown in FIG. 8, the portion where the fuel supply path 50c and the air introducing path 76c are communicated with each other (that is, the communicating section) is located at a higher position than the fuel level in the reserve cup 14. It should be noted that the “portion where the fuel supply path 50c and the air introducing path 76c are communicated with each other” referred to here indicates a portion downstream of the ball 72c when the operation of the fuel pump 20c stops driving. That is, the portion where the third path 75c is in communication with the path therebelow corresponds to “the portion where the fuel supply path 50c and the air introducing path 76c are communicated with each other”, but when the fuel pump 20c stops driving, since this portion is located upstream from the ball 72c, then this portion is not included in the “portion where the fuel supply path 50c and the air introducing path 76c are communicated with each other”. Below, unless expressly stated otherwise, the “portion where the fuel supply path 50 and the air introducing path 76 are communicated with each other” follows the definition stated above.

When the fuel pump 20c is driven, the fuel pump 20c inhales fuel from the inhalation port 28 and pressurizes the fuel. A portion of the pressurized fuel is exhaled from the through hole 29 and the remainder of the fuel goes up in the interior of the fuel pump 20c and is exhaled from the exhalation port 34. When fuel is exhaled from the through hole 29, the fuel flows via the first connecting pipe 52c and into the third path 75c formed inside the second connecting pipe 54c. When the fuel flows into the third path 75c, the ball 72c is pushed up from the lowermost portion to the uppermost portion of the second path 74c, by the fluid force of the fuel, and the air hole sealing valve 70c closes. In this case, a portion of the ball 72c is positioned in a space above the height 118, and retracts from the fuel supply path 50c. Therefore, the communicating section is not closed off by the ball 72c, and the fuel exhaled from the through hole 29 flows smoothly inside the second connecting pipe 54c. When the fuel pump 20c stops driving, the exhalation of fuel from the through hole 29 stops, and the ball 72c drops due to gravitational force and moves to the lowermost portion of the second path 74c. Consequently, the air hole sealing valve 70c opens, air is introduced from the air hole, and the path downstream of the second path 74c of the fuel supply path 50e is kept at atmospheric pressure.

In the third embodiment, fuel is supplied from the lower portion of the fuel pump 20c to the jet pump 60. Furthermore, the through hole 29 according to the present embodiment has a function of expelling vapor which occurs in the fuel when the fuel pump 20c is being driven. Since the jet pump 60 is driven by the fuel expelled from the through hole 29, then there is no need to provide a jet pump exhalation port in the fuel pump 20c. All of the fuel inhaled from the inhalation port 28, apart from the fuel expelled from the through hole 29, can be supplied from the exhalation port to the engine. As a result of this, the pumping efficiency of the fuel pump 20c can be raised.

### First Modification Example

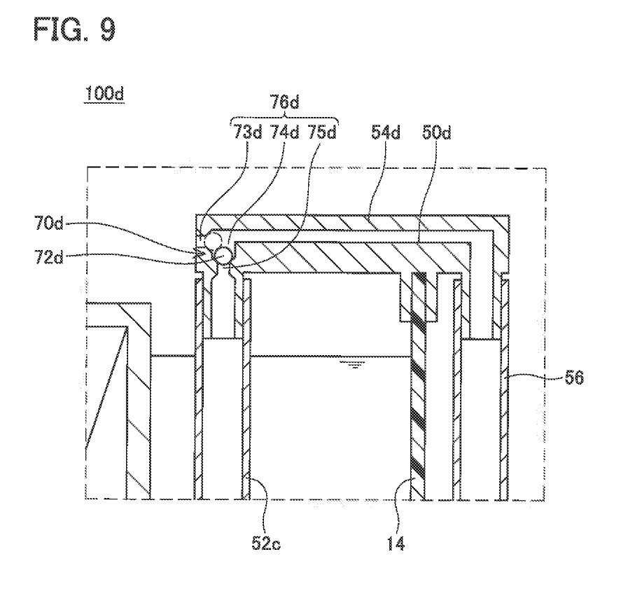

Next, a first modification example of the third embodiment will be described with reference to FIG. 9. Below, only the points which differ from the third embodiment are described, and detailed description of the structure and operation which are the same as the third embodiment is omitted here.

In the fuel supply device according to the first modification example, the first path 73d opens on the side of the second connecting pipe 54d (that is, an air hole is formed therein). The first path 73d is a path which extends in the left/right direction. The shape of the third path 75d is similar to that of the third embodiment. Consequently, the second path 74d which is interposed between the first path 73d and the third path 75d is formed obliquely. Although the second path 74d is formed obliquely, below, for the purposes of the description, the vicinity of the end portion of the second path 74d on the side in communication with the first path 73d is called the “upper portion of the second path 74d”, and the vicinity of the end portion of the second path 74d on the side in communication with the third path 75d is called the “lower portion of the second path 74d”. Moreover, the definitions of “uppermost portion of the second path 74d” and “lowermost portion of the second path 74d” are as in the third embodiment. Taper sections are formed respectively in the upper portion and lower portion of the second path 74d. A ball 72d is accommodated in the second path 74d. An air hole sealing valve 70d is constituted by the air introducing path 76d and the ball 72d.

When the fuel pump is driven, the ball 72d is pushed up by the fluid force of the fuel which has been exhaled from the through hole. The ball 72d moves along the taper section in the upper portion of the second path 74d, and the air hole sealing valve 70d closes. In this case, a portion of the ball 72d is positioned in the first path 73d and the taper section of the second path 74d, and retracts from the fuel supply path 50d. Consequently, the fuel exhaled from the through hole flows smoothly via the first connecting pipe 52c and along the second connecting pipe 54d, and is supplied to the jet pump. When the fuel pump stops driving, the ball 72d drops due to gravitational force. In this case, since a taper section is formed in the lower portion of the second path 74d, then the ball 72d moves along the incline of the taper section until reaching the lowermost portion of the second path 74d. Consequently, the air hole sealing valve 70d opens, air is introduced from the air hole, and the fuel supply path 50d is kept at atmospheric pressure. By adopting a composition of this kind, the first modification example can display a similar action and effect to the third embodiment.

### Second Modification Example

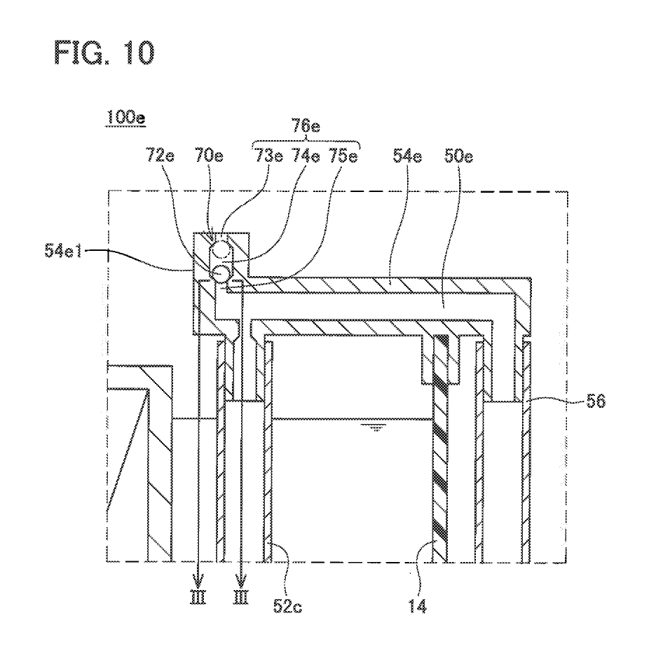

Next, a second modification example of the third embodiment will be described with reference to FIG. 10. Below, only the points which differ from the third embodiment are described, and detailed description of the structure, operation and advantages which are the same as the third embodiment is omitted here.

In the fuel supply device according to the second modification example, a projecting pipe 54e1 such as that shown in FIG. 10 is formed in the second connecting pipe 54e, and an air introducing path 76e is formed inside the projecting pipe 54e1. The air introducing path 76e is composed by a first path 73e, a second path 74e and a third path 75e. The first path 73e opens in the upper portion of the projecting pipe 54e1 (that is, an air hole is formed). The third path 75e is in communication with the fuel supply path 50e. A ball 72e is accommodated in the second path 74e. An air hole sealing valve 70e is constituted by the air introducing path 76e and the ball 72e. As FIG. 10 reveals, the projecting pipe 54e1 is formed on the outside of the fuel supply path 50e. That is, the air hole sealing valve 70e is disposed on the outside of the fuel supply path 50e. The air introducing path 76e is formed in such a manner that, in the portion where the fuel supply path 50e and the air introducing path 76e are communicated with each other (that is, in the third path 75e), the direction in which the fuel supply path 50e extends (that is, the left/right direction) and the direction in which the air introducing path 76e extends (in other words, the up/down direction) are mutually intersecting. Furthermore, the shape of the cross-section along line III-III (namely, the cross-section at the boundary between the second path 74e and the third path 75e) is the same as the shape of the cross-section 80 (see FIG. 3). Accordingly; the second path 74e and the third path 75e are always communicated with each other by projecting sections 80a, 80b, regardless of the position of the ball 72e.

When the fuel pump is driven, the ball 72e is pushed up from the lowermost portion to the uppermost portion of the second path 74e, by the fluid force of the fuel exhaled from the through hole. Consequently, the air hole sealing valve 70e closes. When the fuel pump stops driving, the ball 72e drops due to gravitational force and moves to the lowermost portion of the second path 74e. Consequently, the air hole sealing valve 70e opens. When the air hole sealing valve 70e opens, air is taken in via the air hole, and the interior of the fuel supply path 50e also becomes atmospheric pressure via the paths 73e, 74e, 75e.

The air hole sealing valve 70e according to the second modification example is disposed on the outside of the fuel supply path 50e. Therefore, the fuel flowing in the fuel supply path 50e can be supplied to the jet pump without being obstructed by the air hole scaling valve 70e. Consequently, decline in the efficiency of the jet pump can be suppressed. Moreover, since the air introducing path 76e is formed so as to intersects with the fuel supply path 50e, then the air hole sealing valve 70e has a simple structure which can be opened and closed by gravitational force and the fluid force of the fuel.

### Third Modification Example

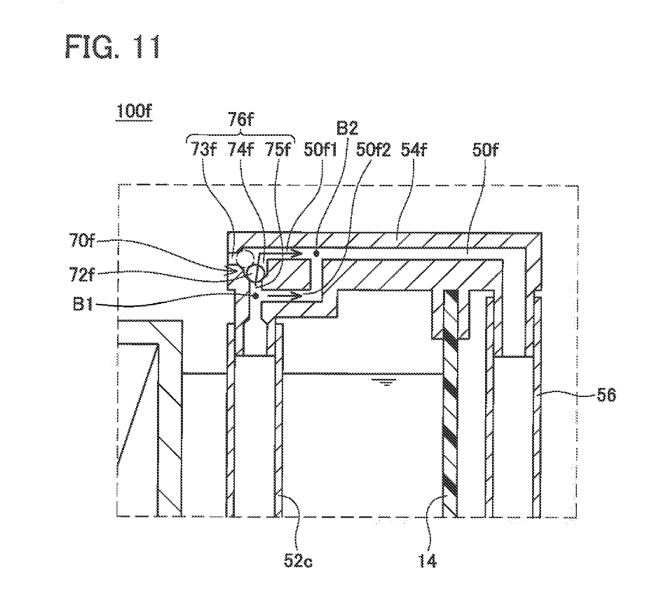

Next, a third modification example of the third embodiment will be described with reference to FIG. 11. Below, only the points which differ from the first modification example of the third embodiment are described, and detailed description of the structure, operation and advantages which are the same as the first modification example of the third embodiment is omitted here.

In the fuel supply device according to the third modification example, a fuel supply path 50f in a second connecting pipe 54f branches into two paths at a branch start point B1 (these two paths are respectively referred to below as a first fuel supply path 50f1 and a second fuel supply path 50f2), and converges at a branch end point B2. The second fuel supply path 5012 branches from the first fuel supply path 50f1 at the branch start point B1, extends in parallel with the first fuel supply path 50f1, and converges with the first fuel supply path 50f1 at the branch end point B2. Therefore, the outer shape of lines linking the axis line of the first fuel supply path 50f1 and the axis line of the second fuel supply path 5012 is a rectangular shape. An air introducing path 76f is connected to the first fuel supply path 50f1. The composition in which the air introducing path 76f is connected to the first fuel supply path 50f1 is similar to the composition in which the air introducing path 76d is connected to the fuel supply path 50d in the first modification example, and therefore description thereof is omitted here.

When the fuel pump is driven, the fuel exhaled from the through hole flows into the fuel supply path 50f in the second connecting pipe 541. The fuel that has flown into the fuel supply path 50f branches at the branch start point B1, a portion of the fuel flows into the third path 75f of the air introducing path 76f which is connected to the first fuel supply path 50f1, and the remainder of the fuel flows into the second fuel supply path 5012. When the fuel flows into the third path 75f, the ball 72f is pushed up to the uppermost portion of the second path 74f, by the fluid force of the fuel, and the air hole sealing valve 70f closes. In this case, a portion of the ball 72f is positioned in the first path 73f and the taper section of the second path 74f, and retracts from the first fuel supply path 50f1. When the fuel pump stops driving, the ball 72f drops due to gravitational force and moves to the lowermost portion of the second path 74f. Consequently, the air hole sealing valve 70f opens, air is introduced into the first fuel supply path 50f1 from the air hole, and the fuel supply path 50f is kept at atmospheric pressure.

By adopting this composition, when the air hole sealing valve 70f is closed, a portion of the ball 72f retracts from the first fuel supply path 50f1, and therefore the fuel can be supplied to the jet pump via the first fuel supply path 50f1. Moreover, since the second fuel supply path 5012 branches from the branch start point B1, then the fuel can also be supplied to the jet pump via the second fuel supply path 50f2, and not just via the first fuel supply path 50f1. Consequently, decrease in the amount of fuel flowing in the fuel supply path 50f can be suppressed more reliably.

### Fourth Embodiment

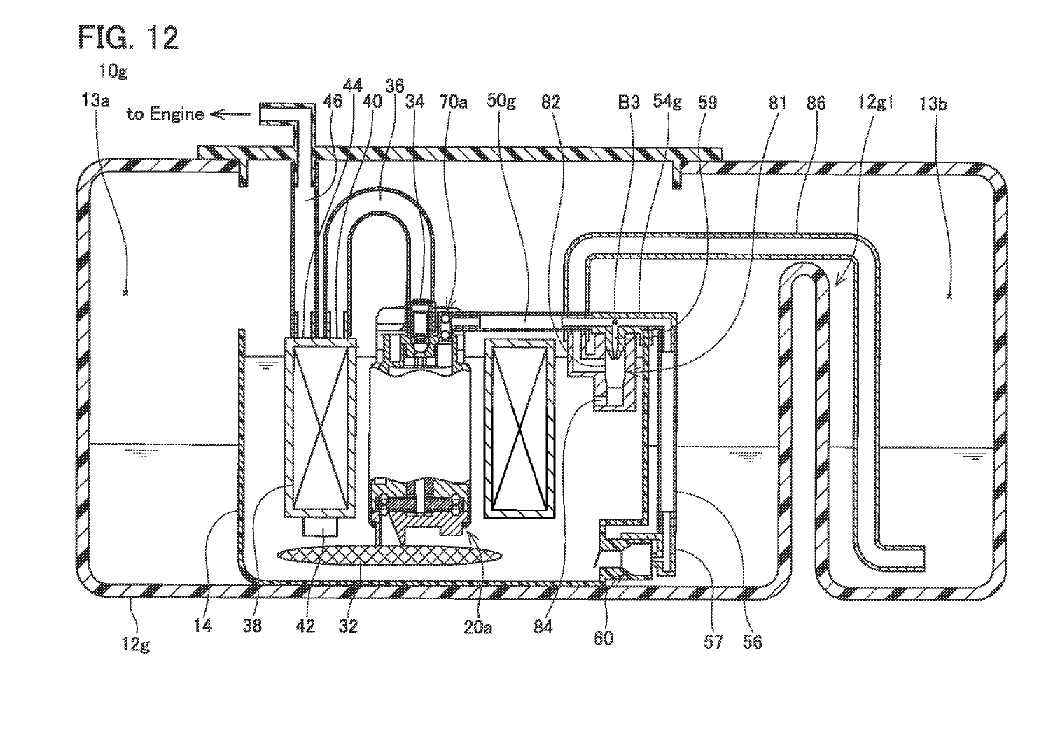

A fuel supply device 10g according to a fourth embodiment of the invention will now be described with reference to FIG. 12. In the fuel supply device 10g according to the fourth embodiment, a portion of the fuel supply device 10a according to the second embodiment is modified. Therefore, here, the points of difference with respect to the fuel supply device 10a according to the second embodiment will be described. Members which are the same as the fuel supply device 10a according to the second embodiment are labeled with the same reference numerals, and detailed description thereof is omitted here.

In the fuel supply device 10g according to the fourth embodiment, the fuel tank 12g is a saddle shape having a partition wall 12g1, and is divided into a first fuel chamber 13a and a second fuel chamber 13b by this partition wall 12g1. A reserve cup 14 is disposed inside the first fuel chamber 13a. A fuel pump 20a, a filter 38, a jet pump 60 and a jet pump 81 are accommodated inside the reserve cup 14. Fuel is reserved respectively in the reserve cup 14, the first fuel chamber 13a and the second fuel chamber 13b.

The second connecting pipe 54g which constitutes a portion of the fuel supply path 50g branches into two pipes from a branch point 133. One pipe is connected to the third connecting pipe 56 and a spray port 59 is formed in the other pipe. A jet pump 81 is provided with the spray port 59, an inhalation port 82 and an exhalation port 84. A transporting pipe 86 is connected to a pipe which forms the inhalation port 82 (called the “inhalation pipe” below). The transporting pipe 86 extends from the inhalation pipe situated inside the first fuel chamber 13a, straddles the partition wall 12g1, and extends to the bottom portion of the second fuel chamber 13b.

When the fuel pump 20a is driven, a portion of the pressurized fuel which has been pressurized by the fuel pump 20a is exhaled from the jet pump exhalation port 48. The exhaled fuel pushes the ball 72a up to the uppermost portion of the second path 74a, by a fluid force thereof, whereby the air hole sealing valve 70a closes. At the branch point B3, a portion of the fuel flowing in the fuel supply path 50g is supplied to the jet pump 60 via the third connecting pipe 56 and the fourth connecting pipe 57, and the remainder of the fuel is sprayed from the spray port 59. In so doing, the periphery of the spray port 59 becomes a negative pressure, the jet pump 81 inhales the fuel inside the second fuel chamber 13h via the inhalation pipe and the transporting pipe 86, from the inhalation port 82, and exhales the fuel from the exhalation port 84 to the interior of the reserve cup 14. That is, the jet pump 81 transports the fuel inside the second fuel chamber 13h to the reserve cup 14. When the fuel pump 20a stops driving, the air hole sealing valve 70a opens, air is introduced from the air hole, and the fuel supply path 50g, the jet pump 81, the inhalation pipe and the transporting pipe 86 are kept at atmospheric pressure.

In the fourth embodiment, a second fuel chamber 13b and a transport jet pump 81 are added to the composition of the second embodiment. With a composition of this kind also, similar advantages to those of the second embodiment are obtained. That is, when the fuel pump 20a has stopped driving, the fuel in the reserve cup 14 is prevented from flowing back into the second fuel chamber 13b and the height of the fuel level in the reserve cup 14 can be kept constant. In the fourth embodiment, the fuel pump 20a was used, but the type of fuel pump is not limited to this, and the fuel pump 20 may also be used, for example.

The embodiments disclosed by the present description were explained in detail above, but these embodiments are simply examples and the fuel pump disclosed by the present description include various modifications of the abovementioned embodiments. For example, in the embodiment described above, a fuel supply path was formed by joining together metal connecting pipes, but the fuel supply path may also be formed by using pipes made of nylon, for instance. Nylon pipes have good flexibility, and therefore the connections of the fuel supply path, and the like, can be made easily. Furthermore, in the embodiments described above, a taper section is formed in the second path, but as long as a ball is pushed up appropriately to the uppermost portion of the second path by the fluid force of the fuel and drops down appropriately to the lowermost portion of the second path due to gravitational force, a tapered section does not have to be formed in the second path. That is, the diameter of the second path may be constant in the axial direction. Furthermore, in the embodiments described above, the air introducing path is composed by a first path, a second path and a third path, but it is also possible to adopt a composition that does not have a first path. That is, an air hole may be formed by opening the front end of the taper section of the second path, in the upper body or in the second connecting pipe. If a composition of this kind is adopted also, advantages similar to those of the embodiments described above are obtained. Moreover, it is also possible to omit the second connecting pipe 54 and to form the first connecting pipe 52 and the third connecting pipe 56 in an integrated fashion.

What is claimed is:

1. A fuel supply device comprising:
a fuel tank;
a reserve cup disposed inside the fuel tank;
a fuel pump disposed inside the reserve cup, and configured to inhale fuel in the reserve cup to exhale a part of the fuel to outside the fuel tank;
a jet pump driven by another part of the fuel exhaled by the fuel pump, and configured to inhale fuel in the fuel tank to exhale the fuel to inside the reserve cup;
a fuel supply path connecting the fuel pump with the jet pump, and configured to supply the other part of the fuel exhaled by the fuel pump to the jet pump;
an air introducing path in communication with the fuel supply path, and including an air hole configured to introduce air from outside the fuel pump; and
a gating mechanism configured to close the air hole when the fuel pump is driven, and to open the air hole when the fuel pump stops driving.

2. The fuel supply device according to claim 1, wherein a portion where the fuel supply path and the air introducing path are communicated with each other is located at a higher position than a fuel level in the reserve cup when the reserve cup reserves a necessary amount of fuel to start driving the fuel pump.

3. The fuel supply device according to claim 2, wherein the gating mechanism is disposed outside the fuel supply path.

4. The fuel supply device according to claim 3, wherein the air introducing path is disposed inside the fuel pump, and a portion where the fuel supply path and the air introducing path are communicated with each other is located inside the fuel pump.

5. The fuel supply device according to claim 4, wherein
the gating mechanism comprises a valve element and a valve seat, and
the valve element makes tight contact with the valve seat to close the air hole by a fluid force of the fuel when the fuel pump is driven.

6. The fuel supply device according to claim 1, wherein at least a portion of the gating mechanism is disposed inside the fuel supply path.

7. The fuel supply device according to claim 6, wherein the air introducing path is disposed inside the fuel pump, and a portion where the fuel supply path and the air introducing path are communicated with each other is located inside the fuel pump.

8. The fuel supply device according to claim 7, wherein
the gating mechanism is disposed inside the fuel supply path in a case where the gating mechanism opens the air hole, and
at least a part of the gating mechanism retracts from the fuel supply path in a case where the gating mechanism closes the air hole.

9. The fuel supply device according to claim 8, wherein
the gating mechanism comprises a valve element and a valve seat, and
the valve element makes tight contact with the valve seat to close the air hole by a fluid force of the fuel when the fuel pump is driven.

10. The fuel supply device according to claim 1, wherein the air introducing path is disposed outside the fuel pump, and a portion where the fuel supply path and the air introducing path are communicated with each other is located outside the fuel pump.

11. The fuel supply device according to claim 10, wherein at least a portion of the gating mechanism is disposed inside the fuel supply path.

12. The fuel supply device according to claim 11, wherein
the fuel supply path comprises a first fuel supply path, and a second fuel supply path that is branched from the first fuel supply path and is parallel with the first fuel supply path, and
the air introducing path is connected with either the first fuel supply path or the second fuel supply path.

13. The fuel supply device according to claim 12, wherein
the gating mechanism comprises a valve element and a valve seat, and
the valve element makes tight contact with the valve seat to close the air hole by a fluid three of the fuel when the fuel pump is driven.

14. The fuel supply device according to claim 1, wherein the gating mechanism is disposed outside the fuel supply path.

15. The fuel supply device according to claim 14, wherein the fuel supply path and the air introducing path are connected with each other, and an extending direction of the fuel supply path intersects with an extending direction of the air introducing path at a portion where the fuel supply path and the air introducing path are connected with each other.

16. The fuel supply device according to claim 15, wherein
the gating mechanism comprises a valve element and a valve seat, and
the valve element makes tight contact with the valve seat to close the air hole by a fluid force of the fuel when the fuel pump is driven.

17. The fuel supply device according to claim 1, wherein
the gating mechanism comprises a valve element and a valve seat, and
the valve element makes tight contact with the valve seat to close the air hole by a fluid force of the fuel when the fuel pump is driven.
